(19) United States
(12) Patent Application Publication
(10) Pub. No.: US 2002/0101550 A1
(43) Pub. Date: Aug. 1, 2002

(54) Backlight module for a liquid crystal display

(75) Inventor: Chun-Lin Yeh, Yung Kang City (TW)

Correspondence Address: BACON & THOMAS, PLLC, 625 SLATERS LANE, FOURTH FLOOR, ALEXANDRIA, VA, 22314

(73) Assignee: AU Optronics Corp., Hsinchu City (TW)

(21) Appl. No.: 10/059,228

(22) Filed: Jan. 31, 2002

(30) Foreign Application Priority Data
Jan. 31, 2001 (TW) 90101969

(51) Int. Cl. G02F 1/1335

(52) U.S. Cl. 349/65

(57) ABSTRACT

A backlight module for a liquid crystal display is disclosed, which has a light source; a lightguide; a reflector having a cavity for locating said light source and reflecting the light from said light source; a reflecting plate, locating on the bottom surface of said lightguide to reflect the light back into said lightguide; and at least one light-absorption unit or light-shielding unit locating between the edge of said reflector and said lightguide for attenuating part of the light which is not totally reflected in said lightguide; wherein said reflector mounted on one side of said lightguide.

### BACKGROUND OF THE INVENTION

1. Field of the Invention

The present invention relates to a backlight module for a flat panel display and, more particularly, to a backlight module for a liquid crystal display device.

2. Description of Related Art

Liquid crystal display devices are popular in recent years since these flat panel displays are thin, small and light-weighed. In most cases, liquid crystal display devices include a liquid crystal display panel and a backlight module. The backlight module is used to provide a homogeneous plate light for the liquid crystal display panel to display images, or films since the liquid crystal display panel cannot emit light itself. The conventional backlight module for a liquid crystal display panel, as shown in FIG. 1, comprises a light source 300, a reflector 210, a lightguide 110, and a reflecting plate 120. The lightguide 110 is a plate used as a medium for dispersing aid emitting the light homogeneously through total reflection when the lightguide 110 is combined with a reflecting plate 120. In most cases, the inner surface of the reflector 110 is coated with a mirror material (or a reflecting material). The light from the light source 300 is reflected by the inner surface of the reflector 210. The light is then reflected into the lightguide 110 and emits out from the top surface of the lightguide 110 homogeneously. Most of the light from the light source 300 is totally reflected in the lightguide 110 more than once before emits out of the lightguide 110. The light is totally reflected in the lightguide 110 through the assistance of the lightguide 110 and the reflecting plate 120. However, since the edge of the lightguide 110 is not perfectly vertical to the reflector 120, part of the light form the light source 300 is not totally reflected in the lightguide 110 as the light goes into the lightguide 110. Part of the light goes through the lightguide 110 and emits out from the top surface of the lightguide 110 without total reflection (as shown in FIG. 1). Most of the time, this kind of light resulted in a shining band close to the side of the lightguide 110. In other words, the shining band can be found on at least the side of the lightguide which is close to the light source (or the reflector). As the backlight module is combined with a liquid crystal display panel, the display quality of the liquid crystal panel deteriorates if the shining band cannot be reduced or eliminated effectively (since the light does not distributed on the panel homogeneously).

One of the options for reducing the shining band effect is to use a bigger frame mask to cover the area of shining band. However, this also means that the reduction of the active area of the panel for displaying images, or films is inevitable. In other words, the percentage of an active area for a display panel is lowered. In recent years, a big area screen with micro-particles is suggested to reduce the shining band effect. However, only part of the shining band can be reduced. In addition, the cost and the complexity of the manufacturing process increase greatly as the screen with particles is used

Therefore, it is desirable to provide an improved the aforementioned problems.

### SUMMARY OF THE INVENTION

The object of the present invention is to provide a simple backlight module for a liquid crystal display device to reduce or eliminate the shining band effectively and economically, to increase the active area of the liquid crystal display panel, and to improve the display quality of the liquid crystal display panel.

To achieve the object, the backlight module for a liquid crystal display, of the present invention includes a light source; a lightguide; a reflector having a cavity for locating said light source and reflecting the light from said light source; a reflecting plate, locating on the bottom surface of said lightguide to reflect the light back into said lightguide; and at least one light-absorption unit or light-shielding unit locating between the edge of said reflector and said lightguide for attenuating part of the light which is not totally reflected in said lightguide; wherein said reflector mounted on one side of said lightguide.

Other objects, advantages, and novel features of the invention will become more apparent from the following detailed description when taken in conjunction with the accompanying drawings.

### BRIEF DESCRIPTION OF THE DRAWINGS

FIG. 1 is a cross-section view of a backlight module of a prior art.

FIG. 2 is a cross-section view of a backlight module of the first embodiment of the present invention.

FIG. 3 is a cross-section view of a backlight module of the second embodiment of the present invention

FIG, 4 is a cross-section view of a backlight module of the third embodiment of the present invention.

FIG. 5 is a cross-section view of a backlight module of the fourth embodiment of the present invention.

FIG. 6 is a cross-section view of a backlight module of the fifth embodiment of the present invention.

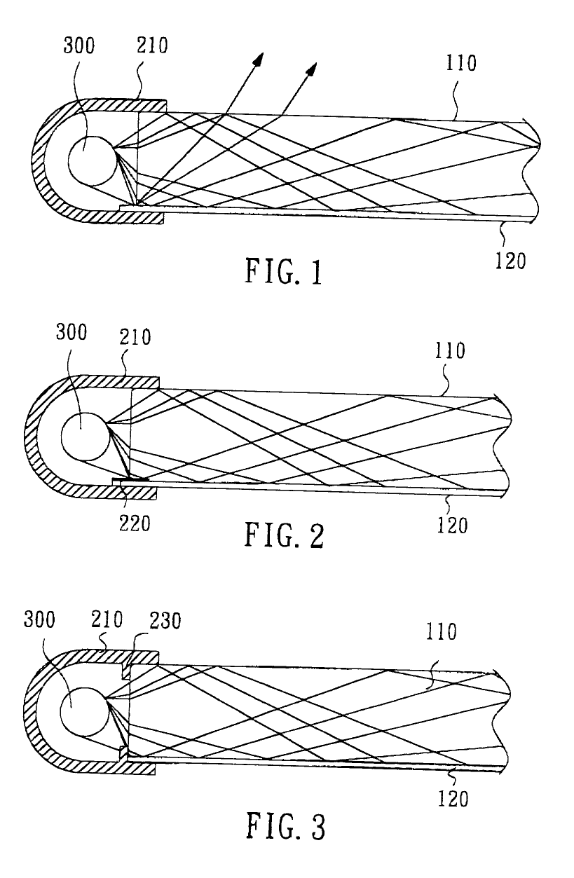

### DETAILED DESCRIPTION OF THE PREFERRED EMBODIMENT

The light-absorption unit of the present invention can locate on the surface of the reflector, the reflecting plate or the lightguide. The light-absorption unit can be an independent unit or a unit integrated with the reflector, the reflecting plate or the lightguide. The shape of the light-absorption of the present invention can be any conventional shape. Preferably, the light-absorption unit of the present invention is a ring or a stripe of light-absorption material. Most preferably, the light-absorption material is a black dye. The light-absorption unit of the present invention can be a continuous or discontinuous ring or stripe of light-absorption material. Preferably, the light-absorption of the present invention is a linear stripe of light-absorption material. The width of the stripes the plate or the ring of the light-absorption material can be any width that can attenuate or reduce the intensity of the light not totally reflected in the lightguide. Preferably, the width of the stripe, the plate, or the ring of the light-absorption of the present invention is equal to or less than 3 mm. Most preferably, he width of the stripe, the plate, or the ring of the light-absorption of the present invention is equal to or less than 1 mm The stripe, the plate, or the ring of the light-absorption of the present invention is can be formed by any conventional process. Preferably, the stripe, the plate, or the ring of the light-absorption of the present invention forms by printing, coating or adhering. The light-shielding unit of the present invention can locate on the surface of the reflector, reflecting plate and the lightguide. The light-shielding unit of the present invention can be an independent unit or a unit integrated with the reflector, the reflecting plate or the lightguide. The shape of the light-shielding unit of the present invention can be any conventional shape. Preferably, the light-shielding unit of the present invention is a ring or a stripe of a mask or a rampart, which can reduce the intensity of the light that is not totally reflected in the lightguide. The number of the masks or the rampart of the present invention is not limited. Preferably, there is at least one mask or rampart locating between the reflector and the lightguide. The independent light shield unit of the present invention can be attached on the surface of the reflector, the reflecting plate or the lightguide through any conventional method. Preferably, the mask or the rampart of the present invention is attached on the surface of the reflector, reflecting plate or the lightguide through adhering or the assistance of binding unit. The binding unit is preferred to be female/male unit. Since the shape of the edge of the reflector, the reflecting plate or the lightguide can be any shape, the mask or the rampart of the present invention can be either contact of not contact to the reflector, the reflecting unit or the lightguide. Preferably, at least one mask or rampart is respectively next to the reflector, the reflector or the lightguide. The masks or the ramparts next to the reflector, the reflecting plate or the lightguide can be either the same or different. Preferably, the mask or the rampart next to said reflector is different form the mask or the rampart next to said lightguide. The height of the masks or the rampart of the present invention is not limited. Preferably, the height of the masks or the ramparts is less than or equal to 0.25 mm. The shape of the masks or the ramparts can be any conventional shape. Preferably, the masks or the ramparts are wedges with a cross-section of a triangle.

The backlight module of the present invention can further comprise additional optical films to increase the functions or improve the performance of the backlight module. For example, the back light module of the present invention can further include prism film or differs to improve the performance of the backlight module.

With reference to FIG. 2, there is shown the cross-section view of the first embodiment of the backlight module of the present invention. The backlight module comprises a light source 300, a reflector 210, a lightguide 110, a stripe of black light-absorption material 220, and a reflecting plate 120. The reflector 210 has a cavity or a groove for locating the light source 300. The inside surface of the reflector 210 is coated with a reflecting material to reflect the light of the light source 300 into the lightguide 110. The reflecting plate 120 locates on the bottom of the lightguide to reflect the light into the lightguide 110. The light source 300 of the present invention can be any conventional light source. In the present embodiment, the light source 300 is CCFLs (cold cathode fluorescent light) or LEDs (light emitting diode). The edge of the reflecting plate 120 protrudes from the edge of the lightguide and next to the inside surface of the reflector 210. On the surface of the reflecting plate, close to the edge of the lightguide 110, a stripe of black light absorption material 220 locates. In the present embodiment, part of the black light-absorption material is covered by the edge of the lightguide 110. The width of the stripe of the black light-absorption material 220 is about 1 mm. The stripe of the black light-absorption material 220 can be formed on the surface of the reflecting plate 120 through transferring, printing, coating, or adhering. In the embodiment of the present invention, the stripe of the black light-absorption material 220 is a continuous linear stripe. The stripe of the black light-absorption material 220 locates on the edge of the reflecting plate 120 which is close to the lightguide 110.

Since the edge of the lightguide 110 is not perfectly vertical to the reflector 120, part of the light form the light source is not totally reflected in the lightguide 110 as the light goes into the lightguide 110 however, the major part of this kind of light is absorbed by the stripe of the light-absorption material 220. Therefore, the intensity of the light going out of the lightguide 110 without total resection is obviously reduced. In other words, the shining band close to the edge of the backlight module, i.e. the shining band resulted from the light without total reflection, is attenuated or eliminated. Hence, the display quality of the liquid crystal display panel can be improved very obviously.

With reference to FIG. 3, there is shown the cross-section view of the second embodiment of the backlight module of the present invention. The backlight module basically comprises a reflector 210, a reflecting plate 120, a rampart 230 and lightguide 110. The edge of the reflecting plate and the edge of the lightguide close to the reflector is next to at least a rampart (or a mask). The ramparts (or the masks) 230 locate on the inside surface of the reflector 210 and integrated with the reflector 210. The ramparts (or the masks) protrude from the inside surface of the reflector 210 and locate close to the at least one edge of the reflector 210. The height of the rampart (or the mask) can be adjusted on the practical needs. In the present embodiment, the height of the rampart is about 0.25 mm. Since the edge of the lightguide 110 is not perfectly vertical to the reflector 120, part of the light form the light source is not totally reflected in the lightguide 10 as the light goes into the lightguide 110. However, the major part of this kind of light is reduced or eliminated by the rampart (or the mask) 230. Therefore, the intensity of the light going out of the lightguide 110 without total reflection is obviously reduced or eliminated. In other words, the shining band close to the edge of the backlight module, i.e. the shining band resulted from the light without total reflection, is attenuated or eliminated. The display quality of the liquid crystal display panel can be improved very obviously.

With reference to FIG. 4, there is shown the cross-section view of the third embodiment of the backlight module of the present invention. The backlight module of the present embodiment is similar to that of the second embodiment However, the rampart (or the mask) 234 is integrated with the reflecting plate. In other words, the backlight module basically comprises a reflector 210, a reflecting plate 120, a rampart 234 and lightguide 110; wherein the rampart (or the mask) 234 is integrated with the reflecting plate 120. The edge of the lightguide 110 close to the reflector 120 is next to a rampart (or a mask) 234 locating on the edge of the reflecting plate 120. The rampart (or the mask) 234 protrudes from the inside surface of the reflecting plate 120 and locates close to at least one edge of the reflecting plate 120. Since the edge of the lightguide 110 is not perfectly vertical to the reflector 120, part of the light form the light source is not totally reflected in the lightguide 110 as the light goes into the lightguide 110. However, the major part of this kind of light is reduced or eliminated by the rampart (or the mask) 234. Therefore, the intensity of the light going out of the lightguide 110 without total reflection is obviously reduced or eliminated. In other words, the shining band close to the edge of the backlight module, i.e. the shining band resulted from the light without total reflection, is reduced or eliminated. The display quality of the liquid crystal display panel can be improved very obviously.

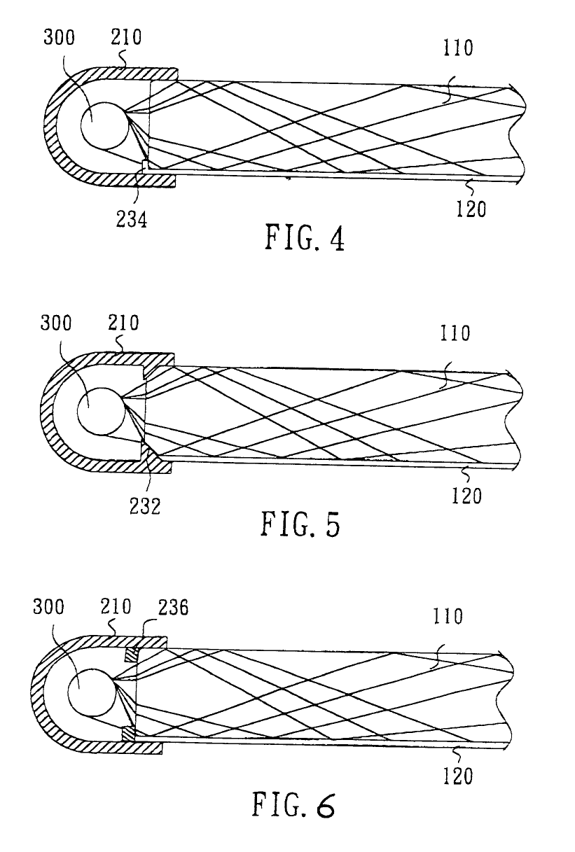

With reference to FIG. 5, there is shown the cross-section view of the fourth embodiment of the backlight module of the present invention. The backlight module of the present embodiment is similar to that of the second embodiment. However, the ramparts (or the masks) 232 of the reflector are wedges with a cross-section of triangle. In other words, the backlight module basically comprises a reflector 210, a reflecting plate 120, a rampart 232 and lightguide 110; wherein the rampart (or the mask) 232 is integrated with the reflector 210. The ramparts (or the masks) protrude from the inside surface of the reflector 210 and locate close to at least one edge of the reflector 210. The height of the rampart (or the mask) can be adjusted for the practical needs. In the present embodiment, the height of the rampart is about 0.25 mm.

Since the edge of the lightguide 110 is not perfectly vertical to the reflector 120, part of the light form the light source is not totally reflected in the lightguide 110 as the light goes into the lightguide 110. However, the major part of this kind of light is reduced or eliminated by the rampart (or the mask) 232. Therefore, the intensity of the light going out of the lightguide 110 without total reflection is obviously reduced or eliminated. In other words, the shining band close to the edge of the backlight module, i.e. the shining band resulted from the light without total reflection, is attenuated or eliminated. The display quality of the liquid crystal display panel can be improved very obviously

With reference to FIG. 6, there is shown the cross-section view of the fifth embodiment of the backlight module of the present invention. The backlight module of the present embodiment is similar to that of the second embodiment. However, the rampart (or the mask) 236 is an independent unit which is not integrated with the reflecting plate. In other words, the backlight module basically comprises a reflector 210, a reflecting plate 120, at least a rampart 236 and lightguide 110. The ramparts (or the masks) 236 can be attached to the inner surface of the reflector through any conventional method. In the present embodiment, the ramparts (or the masks) 236 are attached to the reflector through female/male binding unit. The ramparts (or the masks) 236 combined with the reflector 210 protrude from the inside surface of the reflector 210 and locate close to at least one edge of the reflector 210. The height of the rampart (or the mask) can be adjusted for the practical needs. In the present embodiment, the height of the rampart is about 0.25 mm.

Since the edge of the lightguide 10 is not perfectly vertical to the reflector 120, part of the light form the light source is not totally reflected in the lightguide 110 as the light goes into the lightguide 110. However, the major part of this kind of light is reduced or eliminated by the rampart (or the mask) 236. Therefore, the intensity of the light going out of the lightguide 110 without total reflection is obviously reduced or eliminated. In other words, the shining band close to the edge of the backlight module, i.e. the shining band resulted from the light without total reflection, is attenuated or eliminated. The display quality of the liquid crystal display panel can be improved very obviously. Furthermore, since the shining band close to the edge of the backlight module can be effectively reduced or eliminated, the masks' area around the edge for shielding the shining band can be reduced. In other words, the active area for displaying images, or films for a liquid crystal display panel can be effectively increased as the liquid crystal display panel combined with the backlight module of the present invention,

Although the present invention has been explained in relation to its preferred embodiment, it is to be understood that many other possible modifications and variations can be made without departing from the spirit and scope of the invention as hereinafter claimed.

What is claimed is:

1. A backlight module for a liquid crystal display, comprising:
a light source;
a lightguide;
a reflector having a cavity for locating said light source and reflecting the light from said light source;
a reflecting plate, locating on the bottom surface of said lightguide to reflect the light back into said lightguide; and
at least one light-absorption unit or light-shielding unit locating between the edge of said reflector and said lightguide for attenuating or reducing part of the light which is not totally reflected in said lightguide;
wherein said reflector mounted on one side of said lightguide.

2. The backlight module as claimed in claim 1, wherein said light-absorption unit or said light-shielding unit locating on at least one of the inside surface of said reflector, said reflecting plate or said lightguide.

3.The backlight module as claimed in claim 1, wherein said light-absorption unit or said light-shielding unit is integrated with said reflector, said reflecting plate or said lightguide.

4. The backlight module as claimed in claim 1, wherein said light-absorption unit is a stripe or a plate of light-absorption material.

5. The backlight module as claimed in claim 4, wherein said light-absorption unit is a stripe or a plate of black absorption dye.

6. The backlight module as claimed in claim 5, wherein the width of said stripe or said plate of said light-absorption material is less than or equal to 3 mm.

7. The backlight module as claimed in claim 4, wherein said stripe or said plate of said light-absorption material is attached on the reflector by coating, printing or adhering.

8. The backlight module as claimed in claim 1, wherein said light-absorption unit locates on said reflector and is next to the edge of said lightguide.

9. The backlight module as claimed in claim 1, wherein said light-shielding unit is a mask or a rampart.

10. The backlight module as claimed in claim 9, wherein at least one mask or rampart is next to said reflector or said reflecting plate.

11. The backlight module as claimed in claim 9, wherein at least one mask or rampart is next to said lightguide.

12. The backlight module as claimed in claim 9 to 11, wherein said mask or said rampart next to said reflector is different form said mask or rampart next to said lightguide.

13. The backlight module as claimed in claim 9, wherein the height of said mask or said rampart is less than or equal to 0.25 mm.

14. The backlight module as claimed in claim 9, wherein said mask or said rampart is a wedge.
